(19) United States
(12) Patent Application Publication
(10) Pub. No.: US 2017/0341004 A1
(43) Pub. Date: Nov. 30, 2017

(54) FILTER ELEMENT AND METHOD FOR MAKING THE SAME

(71) Applicant: Unifrax I LLC, Tonawanda, NY (US)

(72) Inventors: Kenneth B. MILLER, Lockport, NY (US); Alastair MCINTYRE, Derby (GB); Jason WEIR, Derby (GB); Herve LHOTE, Ambert (FR); Mauricio Munhoz DE SOUZA, Amherst, NY (US)

(21) Appl. No.: 15/601,130

(22) Filed: May 22, 2017

Related U.S. Application Data
(60) Provisional application No. 62/341,473, filed on May 25, 2016.

(51) Int. Cl. B01D 46/24; B01D 46/00; F01N 3/022

(52) U.S. Cl. CPC B01D 46/2407; B01D 46/0006; B01D 46/0002; F01N 3/022; B01D 2273/20

(57) ABSTRACT

A candle filter comprised of a hollow cylindrical tube having a wall with an interior surface and an exterior surface, wherein the candle filter comprises high temperature resistant inorganic fibers, at least one binder, and optionally a secondary binder, wherein the at least one binder and optional secondary binder is substantially uniformly distributed across the thickness of the candle filter wall. Also, a method for making the candle filter having at least one binder, and optionally a secondary binder at least substantially uniformly distributed across the thickness of the candle filter wall.

### CROSS-REFERENCE TO RELATED APPLICATIONS

This application claims the benefit of the filing date, under 35 U.S.C. §119(e), of U.S. Provisional Application Ser. No. 62/341,473, filed May 25, 2016.

This disclosure relates to a filter element for use in the filtration of high-temperature gases. This disclosure more particularly relates to a candle filter comprised of a hollow cylindrical tube which is uniformly stronger, less susceptible to breakage during operation, and when treated with catalyst material, allows for a more homogeneous distribution of catalyst material across the wall thickness.

Many processes exist wherein a hot gaseous medium is produced which contains particulate material that must be separated from the gaseous medium, either to prevent pollution, or to remove hazardous material.

Hollow ceramic porous filters in a tubular (candle) shape have been used to remove particulate material from hot gases. In these hot gas filtration systems, the porous candle filter traps undesirable particles contained in the flow of hot gases while allowing the cleaned/filtered gas to pass through the pores of the filter into the hollow center of the candle filter. The cleaned/filtered gas travels upwards in the hollow center of the candle filter and emerges from the open end of the candle filter into an upper “clean” chamber and is then exhausted from the chamber through an outlet port.

Generally, a plurality of candle filters are suspended vertically in a pressurized vessel from a tube sheet extending horizontally across the vessel. The tube sheet divides the vessel into two compartments, the lower compartment where the particulate-laden gas enters the vessel, and the upper compartment where the cleaned/filtered gas flows out of the vessel for further use or treatment, or is released into the atmosphere.

Each porous candle filter comprises a hollow cylinder closed at one end and open at the opposite end. The open end of the candle filter may have a flange which allows the candle filter to be coupled to the tube sheet of the vessel. As the particulate-laden gas passes through the porous candle filter, the particulate is trapped on the exterior surface of the candle filter and the cleaned/filtered gas flows through the pores of the candle filter into its hollow center, up and out the open end of the candle filter that is positioned in the upper compartment of the vessel, and exhausted through an exit port of the pressurized vessel.

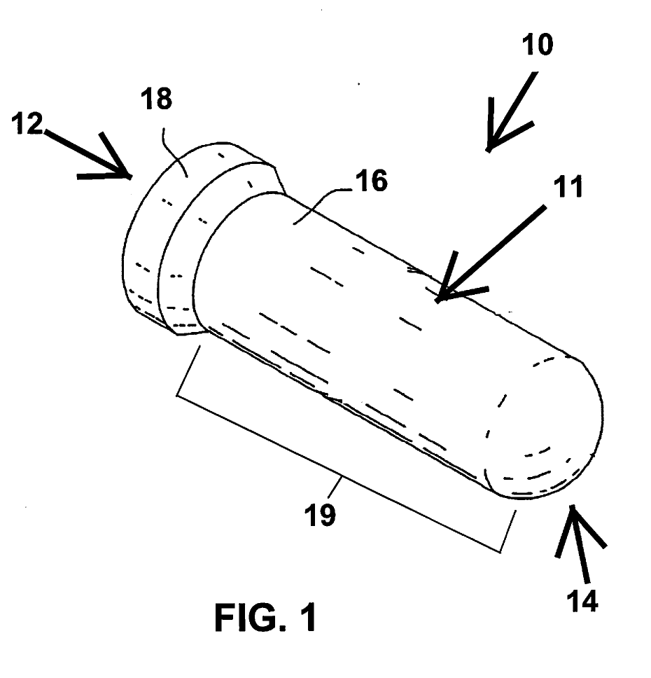

FIG. 1 is a perspective view of one illustrative embodiment of the candle filter.

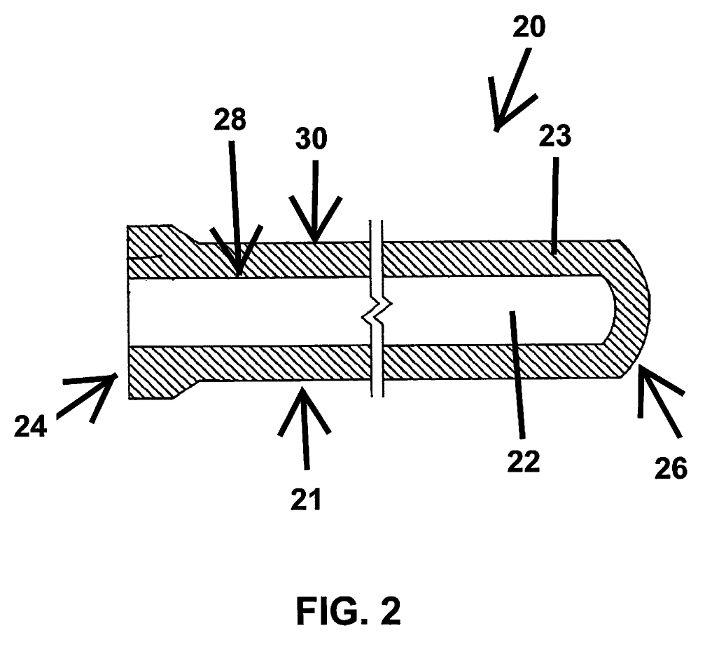

FIG. 2 is a cross-sectional view of the candle filter shown in FIG. 1.

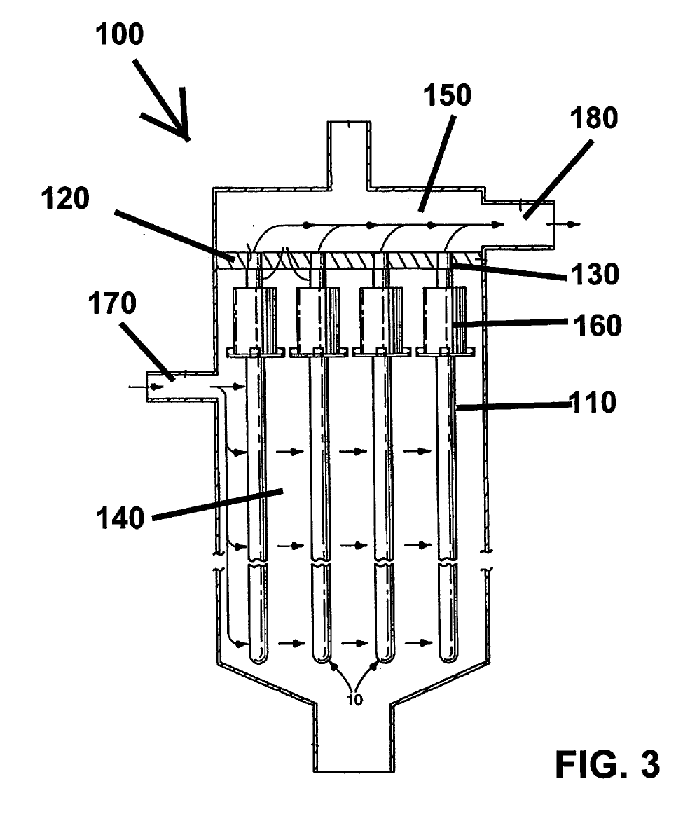

FIG. 3 is a side view, partially in cross section of a pressurized vessel containing a plurality of the candle filters shown in FIGS. 1 and 2.

This disclosure describes embodiments for achieving a candle filter element comprised of a hollow cylindrical tube which is able to withstand the high temperatures encountered in hot gas filtration, which is stronger and less susceptible to breakage during normal handling, which is appreciably stronger in uniform tensile strength as compared to prior art candle filters, and when treated with catalyst material, allows for a more homogeneous distribution of catalyst material across the wall thickness.

The candle filter may comprise a hollow cylindrical tube having a wall with an interior surface and an exterior surface comprising high temperature resistant inorganic fibers, at least one binder, and optionally a secondary binder, wherein the at least one binder and/or secondary binder are substantially uniformly distributed across the thickness of the candle filter wall. With respect to any one of the above-described embodiments, the at least one binder and/or secondary binder may comprise an ammonia-stabilized colloidal metal oxide.

The candle filter may comprise a hollow cylindrical tube having a wall with an interior surface and an exterior surface comprising high temperature resistant inorganic fibers and an ammonia-stabilized colloidal metal oxide binder substantially uniformly distributed across the thickness of the candle filter wall.

The candle filter may comprise a hollow cylindrical tube having a wall with an interior surface and an exterior surface comprising high temperature resistant inorganic fibers, at least one binder and a secondary binder, wherein the at least one binder and/or secondary binder are substantially uniformly distributed across the thickness of the candle filter wall and comprise at least one ammonia-stabilized colloidal metal oxide.

The candle filter may comprise a hollow cylindrical tube having a wall with an interior surface and an exterior surface comprising high temperature resistant inorganic fibers, at least one binder and a secondary binder, wherein the at least one binder and secondary binder are substantially uniformly distributed across the thickness of the candle filter wall.

The candle filter may comprise a flange section and a filtration section, wherein the thickness of the candle filter wall in the flange section is greater than the thickness of the candle filter wall in the filtration section. The candle filter may comprise a flange section and a filtration section, wherein the thickness of the candle filter wall in the flange section is substantially the same as the thickness of the candle filter wall in the filtration section.

The candle filter may comprise a flange section and a filtration section, wherein the density of the candle filter wall in the flange section is greater than the density of the candle filter wall in the filtration section.

The candle filter may comprise an inorganic binder and a separate secondary binder. In certain embodiments, the inorganic binder and the secondary binder comprise a colloidal metal oxide dispersion selected from the group consisting of silica, alumina, titania, zinc, magnesia, zirconia, or combinations thereof. In other embodiments, the colloidal metal oxide dispersion comprises colloidal silica, optionally ammonia-stabilized colloidal silica. The absence of alkali metal stabilizers may have a positive effect on certain catalyst material, thereby increasing catalytic efficiency and effective operating life of the candle filter, as compared to a catalyzed candle filter having an alkali metal stabilized binder.

The inorganic binder and secondary binder may comprise substantially about 100% colloidal silica dispersion, excluding the weight of water. The colloidal silica dispersion may have a solids content of between about 30 to 100% silica, optionally between about 30 to 60% silica.

In certain embodiments, the candle filter comprises at least one catalyst material.

The candle filter may be obtained by a process of vacuum casting in a mould, a slurry containing high temperature resistant inorganic fibers, at least one binder, and a carrier liquid to form a cylindrical green tube; drying the cylindrical green tube to form a rigid filter element; contacting the rigid filter element in a solution or suspension comprising a secondary binder at least once; and vacuum drying the rigid filter element at a pressure sufficient to prevent migration of the secondary binder such that the secondary binder remains at least substantially uniformly distributed across the thickness of the candle filter wall.

A process for producing the candle filter comprises preparing an aqueous slurry and contacting the aqueous slurry with a cylindrical/tube shaped mould, wherein the slurry comprises high temperature resistant inorganic fibers and at least one binder; vacuum casting the slurry on the mould to form a cylindrical green tube having a flange section and a filtration section; drying the cylindrical green tube to form a rigid filter element; contacting the rigid filter element with a solution comprising a secondary binder at least once; and vacuum drying the rigid filter element at a pressure sufficient to prevent migration of the secondary binder such that the secondary binder remains at least substantially uniformly distributed across the thickness of the candle filter wall.

The solution comprising a secondary binder may be re-applied to the filtration and/or the flange section of the rigid filter element and vacuum dried at least one additional time at a pressure sufficient to prevent migration of the secondary binder such that the secondary binder remains at least substantially uniformly distributed across the thickness of the candle filter wall. Conventional filter elements have portions of increased and decreased binder concentrations across the wall thickness which reduces the final mechanical strength of the filter. Also, portions in the filter wall having an increased concentration of binder prevent any subsequently added catalyst material from being uniformly distributed across the wall thickness. Binder material that is present substantially at or near the outer surface of the filter prevents catalyst material that is subsequently applied to the outer surface of the filter from traveling inwards across the wall thickness. This results in a very high concentration of catalyst material at or near the outer surface of the candle filter and little or no catalyst material in the rest of the filter wall. The substantially uniform distribution of binder provided by the disclosed filter allows for a more homogeneous distribution of catalyst material across the wall thickness, when treated with the catalyst material.

In certain embodiments, the rigid filter element is substantially completely soaked in the solution comprising the secondary binder.

The candle filter may comprise a hollow cylindrical tube having a wall with an interior surface and an exterior surface, wherein the candle filter comprises high temperature resistant inorganic fibers, at least one binder, and a secondary binder. In a certain embodiments, the candle filter comprises high temperature resistant inorganic fibers, at least one binder, and a secondary binder, wherein the secondary binder is substantially uniformly distributed across the thickness profile of the candle filter wall.

The candle filter is readily understood when read in conjunction with illustrative FIGS. 1-3. It should be noted that the candle filter is not limited to any of the illustrative embodiments shown in the figures, but rather should be construed in breadth and scope in accordance with the disclosure provided herein.

FIG. 1 is a perspective view of one illustrative embodiment of candle filter 10. Candle filter 10 comprises a hollow body 11 having two opposing ends, one end being a flanged open end 12 and the opposite end being a closed end 14. Candle filter 10 has inner surface (not shown) and outer surface 16. The candle filter has a flange section 18 and a filtration section 19, wherein the thickness of the candle filter wall in the flange section 18 is greater than the thickness of the candle filter wall in the filtration section 19.

FIG. 2 is a cross-sectional view of candle filter 10 shown in FIG. 1. Candle filter 20 has hollow body 21 surrounding a cavity 22 having two opposing ends, one end being an optionally flanged open end 24 and the opposite end being a closed end 26. Candle filter 20 has inner surface 28 and outer surface 30 of the candle filter wall 23.

FIG. 3 is a side view, partially in cross section of pressurized vessel 100 containing a plurality of candle filters 110 as shown in FIGS. 1 and 2. Pressurized vessel 100 comprises an air tight housing or enclosure having a tube sheet 120 that divides pressurized vessel 100 into lower compartment 140 where the particulate-laden gas enters the pressurized vessel 100 and upper compartment 150 where cleaned/filtered gas exits pressurized vessel 100. Tube sheet 120 includes a plurality of apertures 130 communicating with fixture 160 in the gasket assembly from which the candle filters 110 are mounted. Inlet port 170 enables a stream of particulate-laden hot gas to be introduced under pressure into lower compartment 140 of the pressurized vessel 100. This stream of hot gas is forced through the porous walls of candle filters 110 as herein discussed, thus filtering out the particulates on the exterior surface of candle filters 110. The clean/filtered gas emerges from the open end of candle filters 110 through the fixtures 160 into upper compartment 150, and then exits pressurized vessel 100 through outlet port 180.

High temperature resistant inorganic fibers may be utilized in the candle filter that can withstand the operating temperatures of the hot gas filtration system comprising the candle filters. Any fiber which is heat resistant at temperatures above about 1000° C. may be included in the candle filter described herein. Without limitation, suitable inorganic fibers that may be used to prepare the candle filter include high alumina polycrystalline fibers, refractory ceramic fibers such as alumina-silicate (aluminosilicate) fibers, alumina-magnesia-silica fibers, kaolin fibers, calcium aluminate fibers, alkaline earth silicate fibers such as calcia-magnesia-silica fibers or magnesia-silica fibers, S-glass fibers, S2-glass fibers, E-glass fibers, quartz fibers, silica fibers or combinations thereof.

In certain embodiments, the final candle filter comprises at least about 50 weight percent inorganic fiber. In certain embodiments, the final candle filter element comprises at least about 60 weight percent inorganic fiber. In certain embodiments, the final candle filter element comprises at least about 70 weight percent inorganic fiber. In certain embodiments, the final candle filter element comprises at least about 80 weight percent inorganic fiber. In certain embodiments, the final candle filter element comprises at least about 85 weight percent inorganic fiber. In certain embodiments, the final candle filter element comprises at least about 90 weight percent inorganic fiber.

According to certain embodiments, the inorganic fibers that are used to prepare the candle filter comprise ceramic fibers. Without limitation, suitable ceramic fibers include alumina fibers, alumino-silicate fibers, alumina-boria-silicate fibers, alumina-zirconia-silicate fibers, zirconia-silicate fibers, zirconia fibers and similar fibers. A useful alumina-silicate ceramic fiber is commercially available from Unifrax I LLC (Tonawanda, N.Y.) under the registered trademark FIBERFRAX. The FIBERFRAX fibers exhibit operating temperatures of up to about 1540° C. and a melting point up to about 1870° C. The FIBERFRAX fibers can be easily formed into high temperature resistant candle filters.

The alumino-silicate fiber may comprise from about 40 weight percent to about 60 weight percent Al₂O₃ and from about 60 weight percent to about 40 weight percent SiO₂. The alumino-silicate fiber may comprise about 50 weight percent Al₂O₃ and about 50 weight percent SiO₂. The alumino-silicate fiber may comprise about 30 weight percent Al₂O₃ and about 70 weight percent SiO₂. The alumino-silicate fiber may comprise from about 45 to about 51 weight percent Al₂O₃ and from about 46 to about 52 weight percent SiO₂. The alumino-silicate fiber may comprise from about 30 to about 70 weight percent Al₂O₃ and from about 30 to about 70 weight percent SiO₂. The alumino-silica-magnesia glass fiber may comprise from about 64 weight percent to about 66 weight percent SiO₂, from about 24 weight percent to about 25 weight percent Al₂O₃, and from about 9 weight percent to about 10 weight percent MgO.

The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

The terms “low biopersistent” and “biosoluble inorganic fiber” refer to fibers that are soluble or otherwise decomposable in a physiological medium or in a simulated physiological medium such as simulated lung fluid, saline solutions, buffered saline solutions, or the like. The solubility of the fibers may be evaluated by measuring the solubility of the fibers in a simulated physiological medium as a function of time. Biosolubility can also be estimated by observing the effects of direct implantation of the fibers in test animals or by the examination of animals or humans that have been exposed to fibers, i.e. biopersistence.

A method for measuring the biosolubility (i.e. the non-durability) of the fibers in physiological media is disclosed in U.S. Pat. No. 5,874,375 assigned to Unifrax I LLC, which is incorporated herein by reference. Other methods are suitable for evaluating the biopersistence or biosolubility of inorganic fibers. According to certain embodiments, the biosoluble fibers exhibit a solubility of at least 30 ng/cm²-hr when exposed as a 0.1 g sample to a 0.3 ml/min flow of simulated lung fluid at 37° C. According to other embodiments, the biosoluble inorganic fibers may exhibit a solubility of at least 50 ng/cm²-hr, or at least 100 ng/cm²-hr, or at least 1000 ng/cm²-hr when exposed as a 0.1 g sample to a 0.3 ml/min flow of simulated lung fluid at 37° C.

Without limitation, suitable examples of biosoluble alkaline earth silicate fibers that can be used to prepare a candle filter include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

Suitable high temperature resistant biosoluble inorganic fibers that may be used include, without limitation, alkaline earth silicate fibers, such as calcia-magnesia-silicate fibers or magnesia-silicate fibers, calcia-aluminate fibers, potassia-calcia-aluminate fibers, potassia-alumina-silicate fibers, or sodia-alumina-silicate fibers.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of from about 60 to about 90 weight percent silica, from greater than 0 to about 35 weight percent magnesia and optionally 5 weight percent or less impurities. According to certain embodiments, the alkaline earth silicate fibers comprise the fiberization product of from about 65 to about 86 weight percent silica, from about 14 to about 35 weight percent magnesia and optionally 5 weight percent or less impurities. According to certain embodiments, the alkaline earth silicate fibers comprise the fiberization product of from about 70 to about 86 weight percent silica, from about 14 to about 30 weight percent magnesia, and 5 weight percent or less impurities. A suitable magnesium-silicate fiber is commercially available from Unifrax I LLC (Tonawanda, N.Y.) under the registered trademark ISOFRAX. Commercially available ISOFRAX fibers generally comprise the fiberization product of from about 70 to about 80 weight percent silica, from about 18 to about 27 weight percent magnesia and 4 weight percent or less impurities. In certain embodiments, the fibers comprise the fiberization product of about 85 weight percent silica and 15 weight percent magnesia.

According to certain embodiments, the biosoluble alkaline earth silicate fibers may comprise the fiberization product of a mixture of oxides of calcium, magnesium and silica. These fibers are commonly referred to as calcia-magnesia-silicate fibers. According to certain embodiments, the calcia-magnesia-silicate fibers comprise the fiberization product of from about 45 to about 90 weight percent silica, from greater than 0 to about 45 weight percent calcia, from greater than 0 to about 35 weight percent magnesia, and 10 weight percent or less impurities. According to certain embodiments, the calcia-magnesia-silicate fibers may comprise the fiberization product of greater than 71.25 to about 85 weight percent silica, greater than 0 to about 20 weight percent magnesia, about 5 to about 28.75 weight percent calcia, and 0 to about 5 weight percent zirconia.

Useful calcia-magnesia-silicate fibers are commercially available from Unifrax I LLC (Tonawanda, N.Y.) under the registered trademark INSULFRAX. In certain embodiments, the calcia-magnesia-silicate fibers comprise the fiberization product of from about 61 to about 67 weight percent silica, from about 27 to about 33 weight percent calcia, and from about 2 to about 7 weight percent magnesia. In other embodiments, the calcia-magnesia-silicate fibers comprise about 79 weight percent silica, about 18 weight percent calcia, and about 3 weight percent magnesia. Other suitable calcia-magnesia-silicate fibers are commercially available from Thermal Ceramics (Augusta, Ga.) under the trade designations SUPERWOOL 607, SUPERWOOL 607 MAX and SUPERWOOL HT. SUPERWOOL 607 fibers comprise from about 60 to about 70 weight percent silica, from about 25 to about 35 weight percent calcia, from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

According to certain embodiments, the biosoluble alkaline earth silicate fibers may comprise the fiberization product of a mixture of oxides of calcium and aluminum. According to certain embodiments, at least 90 weight percent of the calcia-aluminate fibers comprise the fiberization product of from about 50 to about 80 weight percent calcia, from about 20 to less than 50 weight percent alumina, and 10 weight or less percent impurities. According to other embodiments, at least 90 weight percent of the calcia-aluminate fibers comprise the fiberization product of from about 50 to about 80 weight percent alumina, from about 20 to less than 50 weight percent calcia, and 10 weight percent or less impurities.

According to certain embodiments, the biosoluble alkaline earth silicate fibers may comprise the fiberization product of a mixture of oxides of potassium, calcium and aluminum.

According to certain embodiments, the potassia-calcia-aluminate fibers comprise the fiberization product of from about 10 to about 50 weight percent calcia, from about 50 to about 90 weight percent alumina, from greater than 0 to about 10 weight percent potassia, and 10 weight percent or less impurities.

According to certain embodiments, the biosoluble alkaline earth silicate fibers may comprise the fiberization product of a mixture of oxides of one or more alkaline earths, silica, and other oxide components. Examples include the fiberization product of silica and magnesia; or of silica and calcia; or of silica, magnesia, and calcia; together with lithium oxide. Other examples include the fiberization product of silica and magnesia with oxide components such as strontium oxide, lithium oxide and strontium oxide, or iron oxides. Such fibers may include a viscosity modifier such as alumina and/or boria.

According to certain embodiments, the biosoluble alkaline earth silicate fibers may comprise the fiberization product of a mixture of oxides of magnesium, silicon, lithium and strontium. According to certain embodiments, the biosoluble alkaline earth silicate fibers comprise about 65 to about 86 weight percent silica, about 14 to about 35 weight percent magnesia, and additionally lithium oxide and strontium oxide. According to certain embodiments, the biosoluble alkaline earth silicate fibers comprise about 65 to about 86 weight percent silica, about 14 to about 35 weight percent magnesia, greater than 0 to about 1 weight percent lithium oxide and greater than 0 to about 5 weight percent strontium oxide.

According to certain embodiments, the biosoluble alkaline earth silicate fibers may comprise the fiberization product of silica, magnesia, and up to about 1 weight percent lithium oxide. According to certain embodiments, the biosoluble alkaline earth silicate fibers comprise about 65 to about 86 weight percent silica, about 14 to about 35 weight percent magnesia, and greater than 0 to about 0.45 weight percent lithium oxide. According to certain embodiments, the biosoluble alkaline earth silicate fibers comprise about 65 to about 86 weight percent silica, about 14 to about 35 weight percent magnesia, and greater than 0 to about 5 weight percent strontium oxide. According to certain embodiments, the biosoluble alkaline earth silicate fibers comprise about 70 or greater weight percent silica, magnesia, and greater than 0 to about 10 weight percent iron oxide.

The inorganic fibers may be shortened by chopping or cutting. The fibers may be chopped utilizing any suitable chopping or cutting method, for example, die cutting, guillotine chopping and/or waterjet cutting. The inorganic fibers may be chopped, or cut, in connection with the fiber manufacturing process when the fibers have directionality, or are laminar, rather than randomly arranged. In certain embodiments, the inorganic fibers may be melt-blown fibers, melt-spun fibers, melt-drawn fibers, and/or viscous spun fibers. The candle filter may include a blend of spun and blown inorganic fibers.

In certain embodiments, the final candle filter contains at least about 50 weight percent inorganic fiber. In certain embodiments, the final candle filter contains at least about 60 weight percent inorganic fiber. In certain embodiments, the final candle filter contains at least about 70 weight percent inorganic fiber. In certain embodiments, the final candle filter contains at least about 80 weight percent inorganic fiber. In certain embodiments, the final candle filter contains at least about 85 weight percent inorganic fiber. In certain embodiments, the final candle filter contains at least about 90 weight percent inorganic fiber.

The candle filter also includes a binder or a mixture of more than one type of binder. Suitable binders include organic binders, inorganic binders and/or combinations thereof. According to certain embodiments, the candle filter includes one or more organic binders. Examples of suitable organic binders include, but are not limited to, natural resins, synthetic resins or starch.

The candle filter may also include at least one inorganic binder material, in addition to, or as an alternative to, organic binder. The inorganic binder may be any of those known for their suitability for bonding ceramic fibers. Without limitation, suitable inorganic binder materials include a colloidal dispersion, such as colloidal silica, alumina, zirconia, titania, zinc, magnesia or combinations thereof. The inorganic binder may take the form of a high solids suspension of colloidal silica, such as 30% or greater silica.

In certain embodiments, the final candle filter contains greater than 0 to about 20 weight percent inorganic binder. In certain embodiments, the final candle filter contains greater than 0 to about 15 weight percent inorganic binder. In certain embodiments, the final candle filter contains greater than 0 to about 10 weight percent inorganic binder. In certain embodiments, the final candle filter contains greater than 0 to about 5 weight percent inorganic binder. In certain embodiments, the fmal candle filter contains about 2 to about 10 weight percent inorganic binder. In certain embodiments, the final candle filter contains about 2 to about 7 weight percent inorganic binder. In certain embodiments, the final candle filter contains about 2 to about 5 weight percent inorganic binder.

The inorganic binder may comprise clay. The clay may be calcined or uncalcined, and may include but not be limited to attapulgite, ball clay, bentonite, hectorite, kaolininte, kyanite, montmorillonite, palygorskite, saponite, sepiolite, sillimanite, or combinations thereof.

The candle filter may include at least one flocculating agent. Without limitation, suitable flocculating agents include cationic starch. In certain embodiments, the flocculating agent comprises acrylic latex, polyvinyl chloride, polyvinyl alcohol and/or polyacrylamide. The flocculating agent aids in agglomerating the binder in the slurry which enhances the final mechanical strength of the candle filter.

In certain embodiments, the final candle filter contains greater than about 0 to about 20 weight percent organics content. In certain embodiments, the final candle filter contains greater than about 0 to about 15 weight percent organics content. In certain embodiments, the final candle filter contains greater than about 0 to about 10 weight percent organics content. In certain embodiments, the final candle filter contains greater than about 0 to about 5 weight percent organics content. In certain embodiments, the final candle filter contains about 2 to about 15 weight percent organics content. In certain embodiments, the final candle filter contains about 2 to about 10 weight percent organics content. In certain embodiments, the final candle filter contains about 2 to about 7 weight percent organics content. In certain embodiments, the final candle filter contains about 2 to about 5 weight percent organics content.

The candle filter may include at least one catalyst. The at least one catalyst can provide multiple functionality, that is, it can promote two or more reactions, optionally simultaneously. Alternatively, a combination of catalysts can be used to achieve multiple functionality. Various combinations of catalysts can be applied to the surface of the candle filter and/or distributed substantially uniformly across the thickness profile of the candle filter wall.

In certain embodiments, the candle filter comprises aluminosilicate fibers, ammonia-stabilized colloidal silica, and a catalyst material. The absence of an alkali metal stabilizing agent for the colloidal metal oxide may have a positive effect on certain catalyst material, thereby increasing catalytic efficiency and the effective operating life of the catalyzed candle filter.

The candle filter comprised of a hollow cylindrical tube may be formed by vacuum casting a slurry containing high temperature resistant inorganic fibers, binder, and a carrier liquid such as water. In other embodiments, the candle filter is comprised of a hollow cylindrical tube formed by vacuum casting a slurry containing high temperature resistant inorganic fibers, binder, a flocculating agent, and a carrier liquid such as water. As an illustrative embodiment, inorganic fiber, flocculant, an inorganic binder solution or suspension is mixed with a carrier liquid to form a slurry that is vacuum cast to form a green tube.

In certain embodiments, the slurry of components is wet laid onto a pervious cylindrical/tube shaped mould. A vacuum is applied to the open end of the mould to extract the majority of the moisture from the slurry, thereby forming a wet cylindrical “green” tube, i.e., before the binder has set.

The green tube is dried at a temperature ranging from about 50 to about 300° C., in certain embodiments about 100 to about 150° C. In certain embodiments, the green tube is placed in a drying oven, resulting in a rigid filter element. In certain embodiments, the green tube is partially dried while still on the mould for one or more drying cycles. The green tube may be further dried to form the rigid filter element.

The green tube may be dried by vacuum or other conventional drying methods known in the art. In certain embodiments, drying the rigid filter element before vacuum drying removes excess binder, retaining a sufficient amount to coat the individual fibers.

After the rigid filter element is dried, it may be cooled to room temperature and contacted, dipped or otherwise soaked at least once in a solution or suspension comprising a secondary binder. In certain embodiments, the rigid filter element is submerged into the solution or suspension comprising the secondary binder such that the rigid filter element is completely impregnated with the secondary binder to the point of saturation. In other embodiments, the rigid filter element is partially impregnated with the secondary binder. The impregnated, rigid filter element may then be dried according to the above described procedure.

In certain embodiments, the solution or suspension comprising a secondary binder is spread, brushed, sprayed, and/or coated onto the rigid filter element.

After applying the secondary binder to the rigid filter element, it may be dried under vacuum. In certain embodiments, the rigid filter element is subjected to vacuum drying at a negative pressure and elevated temperatures. After the initial vacuum drying step, the rigid filter element may be further dried by other conventional drying methods known in the art.

In certain embodiments, vacuum drying comprises positioning the rigid filter element in a vertical position, blowing hot air on the exterior surface of the rigid filter element, and applying a vacuum to the open end of the rigid filter element. The vacuum pulls the hot air out of the walls of the rigid filter element to prevent the secondary binder from migrating towards to the “hot” external surface of the candle filter. This prevents any significant displacement or migration of the secondary binder during the drying so that when the rigid filter element has dried the density of the binder will be about the same across the entire thickness profile of the candle filter wall.

In certain embodiments, following drying of the rigid filter element that has been impregnated with the secondary binder, the flange area may be reimpregnated with the secondary binder to provide further strengthening to this section of the candle filter, and then dried as described above.

The solution comprising a secondary binder may be applied to the rigid filter element multiple times before and/or after being subjected to the vacuum drying step. In certain embodiments, the solution comprising a secondary binder is applied at least two times to the flange and/or filtration sections of the candle filter. This additional dipping step increases the density and strength across the thickness profile of the flange and/or filtration sections of the candle filter.

Without limitation, the secondary binder may comprise colloidal metal oxide dispersions selected from the group consisting of silica, alumina, titania, zinc, magnesia, zirconia, or combinations thereof.

Without limitation, suitable secondary binder materials include a colloidal silica solution. In this context, the term “solution” is intended to include slurries or dispersions containing the colloidal inorganic oxides. Commercially available formulations of the colloidal inorganic oxide may be utilized, by way of illustration and not limitation, NALCO colloidal silica, available from Nalco Holding Company, a wholly owned subsidiary of Ecolab, Inc.

In certain embodiments, the colloidal silica solution has a percent by weight solids concentration in excess of 10% silica. In certain embodiments, the colloidal silica solution has a higher solids content, such as 30% or greater silica. In certain embodiments, the colloidal silica solution has a higher solids content, such as 35% or greater silica. In certain embodiments, the colloidal silica solution has a higher solids content, such as 40% or greater silica. It has been found that a colloidal silica solution with a solids concentration of between 30-55% results in particularly good bonding and mechanical strength of the resulting candle filter as compared to conventional colloidal solutions that contain 10 to less than 30 weight percent silica solids.

The colloidal inorganic oxide solution composition may comprise about 30 to 100% by weight colloidal inorganic oxide, excluding the weight of water. In certain embodiments, the colloidal inorganic oxide solution may comprise about 50 to about 90% colloidal inorganic oxide, and in other embodiments, about 80 to 100% colloidal inorganic oxide. In yet other embodiments, the colloidal inorganic oxide solution composition comprises 100% by weight colloidal inorganic oxide.

The colloids of the colloidal metal oxide solution may have a median particle size of between 10-300 nanometers. In certain embodiments, the colloids have a median particle size of between 10-70 nanometers. The colloidal metal oxide solution may contain sols of varying particle sizes.

In certain embodiments, the secondary binder and the at least one binder that is used in the initial slurry with the high temperature resistant fibers to form the green tube are substantially different. In another embodiment, the secondary binder and the at least one binder are substantially similar.

In certain embodiments, the at least one binder and/or the secondary binder are ammonia-stabilized. In certain embodiments, the at least one binder and/or the secondary binder comprise an ammonia-stabilized colloidal silica dispersion. The ammonia-stabilized dispersion may have a sodium content of less than 30 ppm as compared to 600 ppm for sodium-stabilized colloidal dispersions.

During conventional drying methods, the binder tends to migrate to the “hot” exterior surface of the candle filter, thereby causing excessive binder buildup at the exterior surface and leaving insufficient amounts of binder across the thickness profile of the candle filter wall. The “hardening” step of dipping the rigid filter element into a solution comprising a secondary binder and subsequently drying the rigid filter element by vacuum drying prevents this binder migration. The impregnation step allows the secondary binder to be uniformly distributed across the thickness profile of the rigid filter element wall, and the vacuum drying step maintains this uniformity.

The ability to regulate conditions in vacuum drying, such as the amount of positive or negative pressure applied against the surface (the interior surface, the exterior surface, or both the interior and exterior surfaces) of the candle filter, permits a quick, simple and reproducible method for controlling the degree of binder migration across the thickness profile of the candle filter wall. The resulting candle filter is characterized by uniform strength, density, and relative flexibility.

The hardening step not only increases the overall strength of the candle filter but also increases its crack deflection and relative flexibility. As a result of the combined increase in strength and flexibility, the traditional brittleness problems associated with prior art candle filters can be largely avoided. This method also significantly improves the resistance of the candle filter to tearing, allowing it to be easily cut to specified dimensions. The increased hardness and strength imparted by this method advantageously permits the candle filter to be machined to the tight tolerances as may be required by a particular application. Machining can be accompanied by methods conventionally known in the art.

The hardening step allows the secondary binder to remain at least substantially distributed across the thickness profile of the candle filter wall. This method results in increased overall strength, toughness, thermal shock resistance and flexibility as compared to candle filters that do not undergo the hardening step described herein. The increased strength and flexibility of the candle filter also permit the manufacture of longer tubes (greater than 6 meters as compared to conventional 3 meter candle filters). The increased length of the candle filter, greater than 3 meters, enhances the overall efficiency of the candle filter due to its increased volume and surface area.

In certain embodiments, the rigid filter element has a porosity of greater than 80%. In other embodiments, the rigid filter element has a porosity of greater than about 82.5%. In yet other embodiments, the rigid filter element has a porosity of about 82.5 to about 86.5%.

In certain embodiments, the porosity of the final candle filter is greater than about 83 percent, which is sufficient to allow the candle filter to separate particulate matter in a gas stream. The permeability of the candle filter was tested by measuring the pressure drop across the filter at different air velocities. The candle filter had permeabilities (pressure drops) ranging from 5-14 kPa. In certain embodiments, the candle filter demonstrated a loss on ignition of less than about 4 percent.

In certain embodiments, the flange section of the candle filter may have a diameter from about 0.03 to about 0.3 meters and a length of about 0.01 to about 0.05 meters. The filtration section of the candle filter may have a diameter from about 0.01 to about 0.2 meters and a length up to greater than about 6 meters, in certain embodiments about 3 to 6 meters. The filtration section may have a wall thickness of about 0.01 to about 0.05 meters. The effective surface of the candle filter is from about 0.10 to about 2.0 square meters, in certain embodiments. The density of the rigid filter element is about 300 to about 400 kg/m³.

In certain embodiments, the candle filter has a filtration velocity up to about 3 meters per min. The cleaned/filtered gas that passes through the pores of the candle filter typically contains less than 1 milligram per square meter of particulate matter.

A conventional candle filter element was impregnated with a catalyst material containing liquid and was dried. The catalyst material was primarily situated at the surface of the filter and not in the remainder of the thickness of the filter wall. For a filter impregnated and vacuum dried according to the subject process, there was a distribution of catalyst throughout the thickness of the candle filter wall. The catalytic activity of the candle filter with the catalyst distributed throughout the filter wall was enhanced compared to the other candle filter.
1. There is provided a candle filter of a first embodiment comprising a hollow cylindrical tube having a wall with an interior surface and an exterior surface comprising:

high temperature resistant inorganic fibers, at least one binder and optionally a secondary binder, wherein the at least one binder and optional secondary binder is substantially uniformly distributed across the thickness of the candle filter wall and comprises an ammonia-stabilized colloidal metal oxide.
2. There is also provided a candle filter of a second embodiment comprising a hollow cylindrical tube having a wall with an interior surface and an exterior surface comprising:

high temperature resistant inorganic fibers, at least one binder and a secondary binder, wherein the at least one binder and secondary binder are substantially uniformly distributed across the thickness of the candle filter wall and comprise an ammonia-stabilized colloidal metal oxide.
3. There is further provided a candle filter of a third embodiment comprising a hollow cylindrical tube having a wall with an interior surface and an exterior surface comprising: high temperature resistant inorganic fibers, at least one binder and a secondary binder, wherein the at least one binder and secondary binder are substantially uniformly distributed across the thickness of the candle filter wall and comprise a colloidal metal oxide.

4. The candle filter of any one of the embodiments 1-3, may comprise a flange section and a filtration section, wherein the thickness of the flange section is greater than the thickness of the filtration section.
5. The candle filter of any one of embodiments 1-4, may comprise a flange section and a filtration section, wherein the density of the flange section is greater than the density of the filtration section.
6. In the candle filter of any one of embodiments 1-5, the colloidal metal oxide may be selected from the group consisting of silica, alumina, titania, zinc, magnesia, zirconia, or combinations thereof.
7. In the candle filter of embodiment 6, the colloidal metal oxide may comprise colloidal silica.
8. The candle filter of any one of embodiments 1-7, may further comprise at least one flocculating agent.
9. In the candle filter of embodiment 8, the at least one flocculating agent may comprise cationic starch.
10. In the candle filter of any one of embodiments 1-9, the colloidal metal oxide might not contain an alkali metal stabilizing agent.
11. In the candle filter of any one of embodiments 1-10, the candle filter may have a porosity of greater than 80%.
12. In the candle filter of embodiment 11, the porosity may be greater than about 82.5%.
13. In the candle filter of embodiment 11, the porosity may be about 82.5 to 86.5%.
14. The candle filter of any one of embodiments 1-13, may further comprise at least one catalyst material.
15. In the candle filter of embodiment 14, the at least one catalyst material may be substantially uniformly distributed across the thickness of the candle filter wall.
16. In the candle filter of any one of embodiments 1-15, the high temperature resistant inorganic fibers may comprise at least one of high alumina polycrystalline fibers, refractory ceramic fibers, alumina-silicate fibers, alumina-magnesia-silicate fibers, kaolin fibers, calcium aluminate fibers, alkaline earth silicate fibers, calcia-magnesia-silicate fibers, magnesia-silicate fibers, S-glass fibers, S2-glass fibers, E-glass fibers, quartz fibers, silica fibers or combinations thereof.
17. In the candle filter of embodiment 16, the refractory ceramic fibers may comprise alumino-silicate fibers comprising the fiberization product of from about 30 to about 70 weight percent alumina and from about 30 to about 70 weight percent silica.
18. In the candle filter of embodiment 16, the biosoluble fibers may comprise magnesia-silicate fibers comprising the fiberization product of from about 60 to about 90 weight percent silica and from greater than 0 to about 35 weight percent magnesia.
19. In the candle filter of embodiment 16, the biosoluble fibers may comprise calcia-magnesia-silicate fibers comprising the fiberization product of from about 45 to about 90 weight percent silica, from greater than 0 to about 45 weight percent calcia, and from greater than 0 to about 35 weight percent magnesia.
20. The candle filter of any one of embodiments 1-19, may be obtained by a process of:

vacuum casting in a mould, a slurry containing the high temperature resistant inorganic fibers, the at least one binder, and a carrier liquid to form a cylindrical green tube;

drying the cylindrical tube to form a rigid filter element;

soaking the rigid filter element in a solution or suspension comprising the secondary binder at least once; and

vacuum drying the rigid filter element at a pressure sufficient to prevent migration of the secondary binder such that the secondary binder remains at least substantially uniformly distributed across the thickness of the candle filter wall.
21. There is further provided a process for producing a candle filter, comprising preparing an aqueous slurry and contacting the aqueous slurry with a cylindrical/tube shaped mould, wherein the slurry comprises high temperature resistant inorganic fibers and at least one binder;

vacuum casting the slurry on the mould to form a cylindrical green tube having a flange section and a filtration section;

drying the cylindrical green tube to form a rigid filter element;

contacting the rigid filter element with a solution comprising the secondary binder at least once; and

vacuum drying the rigid filter element at a pressure sufficient to prevent migration of the secondary binder such that the secondary binder remains at least substantially uniformly distributed across the thickness of the candle filter wall.
22. In the process of embodiment 21, the secondary binder solution may be re-applied to the rigid filter element, optionally to the flange section of the rigid filter element, and vacuum dried an additional time at a pressure sufficient to prevent migration of the secondary binder such that the secondary binder remains at least substantially uniformly distributed across the thickness of the candle filter wall.
23. In the process of embodiment 21 or 22, the rigid filter element may be substantially completely soaked in the solution comprising the secondary binder.

While the candle filter, and methods of preparing the candle filter have been described in connection with various embodiments, it is to be understood that other similar embodiments may be used or modifications and additions may be made to the described embodiments for performing the same function. It will be understood that the embodiments described herein are merely illustrative, and that one skilled in the art may make variations and modifications without departing from the spirit and scope of the invention. Further, all embodiments disclosed are not necessarily in the alternative, as various embodiments may be combined to provide the desired result.

1. A candle filter comprising a hollow cylindrical tube having a wall with an interior surface and an exterior surface comprising:
high temperature resistant inorganic fibers, at least one binder and optionally a secondary binder, wherein the at least one binder and optional secondary binder is substantially uniformly distributed across the thickness of the candle filter wall and comprises an ammonia-stabilized colloidal metal oxide.

2. A candle filter comprising a hollow cylindrical tube having a wall with an interior surface and an exterior surface comprising:
high temperature resistant inorganic fibers, at least one binder and a secondary binder, wherein the at least one binder and secondary binder are substantially uniformly distributed across the thickness of the candle filter wall and comprise a colloidal metal oxide.

3. The candle filter of claim 2 wherein the colloidal metal oxide is an ammonia-stabilized colloidal metal oxide.

4. The candle filter of claim 2, wherein the colloidal metal oxide is selected from the group consisting of silica, alumina, titania, zinc, magnesia, zirconia, or combinations thereof.

5. The candle filter of claim 4, wherein the colloidal metal oxide comprises colloidal silica, optionally ammonia-stabilized.

6. The candle filter of claim 2, further comprising at least one flocculating agent, optionally wherein the at least one flocculating agent comprises cationic starch.

7. The candle filter of claim 2, wherein the colloidal metal oxide does not contain an alkali metal stabilizing agent.

8. The candle filter of claim 2, wherein the candle filter has a porosity of greater than 80%.

9. The candle filter of claim 2, wherein the porosity is greater than about 82.5%.

10. The candle filter of claim 2, wherein the porosity is about 82.5 to 86.5%.

11. The candle filter of claim 2, further comprising at least one catalyst material.

12. The candle filter of claim 11, wherein the at least one catalyst material is substantially uniformly distributed across the thickness of the candle filter wall.

13. The candle filter of claim 2, wherein the high temperature resistant inorganic fibers comprise at least one of high alumina polycrystalline fibers, refractory ceramic fibers, alumina-silicate fibers, alumina-magnesia-silicate fibers, kaolin fibers, calcium aluminate fibers, alkaline earth silicate fibers, calcia-magnesia-silicate fibers, magnesia-silicate fibers, S-glass fibers, S2-glass fibers, E-glass fibers, quartz fibers, silica fibers or combinations thereof.

14. The candle filter of claim 13, wherein the refractory ceramic fibers comprise alumino-silicate fibers comprising the fiberization product of from about 30 to about 70 weight percent alumina and from about 30 to about 70 weight percent silica.

15. The candle filter of claim 13, wherein the biosoluble fibers comprise magnesia-silicate fibers comprising the fiberization product of from about 60 to about 90 weight percent silica, from greater than 0 to about 35 weight percent magnesia.

16. The candle filter of claim 13, wherein the biosoluble fibers comprise calcia-magnesia-silicate fibers comprising the fiberization product of from about 45 to about 90 weight percent silica, from greater than 0 to about 45 weight percent calcia, and from greater than 0 to about 35 weight percent magnesia.

17. The candle filter of claim 2, obtained by a process of:
vacuum casting in a mould, a slurry containing the high temperature resistant inorganic fibers, the at least one binder, and a carrier liquid to form a cylindrical green tube;
drying the cylindrical tube to form a rigid filter element;
soaking the rigid filter element in a solution or suspension comprising the secondary binder at least once; and
vacuum drying the rigid filter element at a pressure sufficient to prevent migration of the secondary binder such that the secondary binder remains at least substantially uniformly distributed across the thickness of the candle filter wall.

18. A process for producing a candle filter, comprising preparing an aqueous slurry and contacting the aqueous slurry with a cylindrical/tube shaped mould, wherein the slurry comprises high temperature resistant inorganic fibers and at least one binder;
vacuum casting the slurry on the mould to form a cylindrical green tube having a flange section and a filtration section;
drying the cylindrical green tube to form a rigid filter element ;
contacting the rigid filter element with a solution comprising the secondary binder at least once; and
vacuum drying the rigid filter element at a pressure sufficient to prevent migration of the secondary binder such that the secondary binder remains at least substantially uniformly distributed across the thickness of the candle filter wall.

19. The process of claim 18, wherein the secondary binder solution is re-applied to the rigid filter element, optionally to the flange section of the rigid filter element, and vacuum dried an additional time at a pressure sufficient to prevent migration of the secondary binder such that the secondary binder remains at least substantially uniformly distributed across the thickness of the candle filter wall.

20. The process of claim 18, wherein the rigid filter element is substantially completely soaked in the solution comprising the secondary binder.
